(19) United States
(12) Patent Application Publication
(10) Pub. No.: US 2025/0207994 A1
(43) Pub. Date: Jun. 26, 2025

(54) PIPELINE LEAKAGE ACOUSTIC EMISSION SIGNAL DENOISING METHOD, SYSTEM, DEVICE AND MEDIUM

(71) Applicant: China Special Equipment Inspection & Research Institute, Beijing (CN)

(72) Inventors: Bin HU, Beijing (CN); Zhimin CAO, Beijing (CN)

(21) Appl. No.: 18/652,373

(22) Filed: May 1, 2024

(30) Foreign Application Priority Data
Dec. 22, 2023 (CN) 202311788297.8

(51) Int. Cl. G01M 3/24

(52) U.S. Cl. CPC G01M 3/243

(57) ABSTRACT

A pipeline leakage acoustic emission signal denoising method, system, device and medium are provided, and relate to the field of leakage acoustic denoising. The method includes: acquiring pipeline leakage acoustic emission signals; obtaining a plurality of mode components by decomposing the pipeline leakage acoustic emission signals using a sparrow search algorithm and a variational mode decomposition algorithm; obtaining mode components with more noise and mode components with less noise by dividing the plurality of mode components according to a comprehensive index; obtaining denoised mode components by denoising the mode components with more noise using a wavelet packet adaptive threshold; and obtaining denoised leakage acoustic emission signals by carrying out reconstruction according to the mode components with less noise and the denoised mode components. The method, system, device and medium can reserve information of the leakage acoustic emission signals and improve denoising accuracy.

### CROSS-REFERENCE TO RELATED APPLICATION

This patent application claims the benefit and priority of Chinese Patent Application No. 2023117882978 filed with the China National Intellectual Property Administration on Dec. 22, 2023, the disclosure of which is incorporated by reference herein in its entirety as part of the present application.

### TECHNICAL FIELD

The present disclosure relates to the field of leakage acoustic denoising, in particular to a pipeline leakage acoustic emission signal denoising method, system, device and medium.

### BACKGROUND

Pipeline transportation plays a key role in urban economic development, but pipeline leakage may be resulted from corrosion, aging and external interference. Metal pipelines are prone to leak due to cracks and corrosion, while plastic pipelines have been widely used to transport fluids and gases in recent years because of their advantages such as oxidation resistance and corrosion resistance. Therefore, it is of great significance to explore accurate leakage detection methods for plastic pipelines and take effective measures in time to reduce economic losses.

In the process of detecting the leakage using acoustic emission signals caused by pipeline leakage, the actual leakage acoustic emission signals are inevitably mixed with a lot of noise due to the interference from the surrounding environment, which further affects accuracy of leakage detection and location. It is very important to choose an appropriate method to reduce the noise of the leakage acoustic emission signals.

### SUMMARY

The present disclosure aims to provide a pipeline leakage acoustic emission signal denoising method, system, device and medium, which can reserve information of the leakage acoustic emission signals and improve denoising accuracy.

In order to achieve the above objective, the present disclosure provides the following scheme.

A pipeline leakage acoustic emission signal denoising method includes:
acquiring pipeline leakage acoustic emission signals;
obtaining a plurality of mode components by decomposing the pipeline leakage acoustic emission signals using a sparrow search algorithm and a variational mode decomposition algorithm;
obtaining mode components with more noise and mode components with less noise by dividing the plurality of mode components according to a comprehensive index; obtaining denoised mode components by denoising the mode components with more noise using a wavelet packet adaptive threshold; and
obtaining denoised leakage acoustic emission signals by carrying out reconstruction according to the mode components with less noise and the denoised mode components.

In one embodiment, obtaining the plurality of mode components by decomposing the pipeline leakage acoustic emission signals using the sparrow search algorithm and the variational mode decomposition algorithm, specifically includes:
obtaining the number of mode decomposition layers and a penalty factor by carrying out optimization using the sparrow search algorithm; and
obtaining the plurality of mode components by decomposing the pipeline leakage acoustic emission signals using the variational mode decomposition algorithm according to the number of mode decomposition layers and the penalty factor.

In one embodiment, the comprehensive index includes a K-L divergence value, a Pearson correlation coefficient, an energy value and a variance contribution rate.

In one embodiment, obtaining the denoised mode components by denoising the mode components with more noise using a wavelet packet adaptive threshold, specifically including:
obtaining a scale function and a decomposition function by carrying out wavelet packet decomposition on the mode components with more noise; and
obtaining the denoised mode components by denoising and reconstruction using a hard threshold function according to the scale function and the decomposition function.

In one embodiment, after obtaining the denoised leakage acoustic emission signals by carrying out reconstruction according to the mode components with less noise and the denoised mode components, the method further includes:
obtaining a time-frequency signal by carrying out short-time Fourier transform on the denoised leakage acoustic emission signals;
calculating an instantaneous frequency according to phase information of the time-frequency signal; and
obtaining time-frequency features of the leakage acoustic emission signals according to a time-frequency coefficient of the time-frequency signal at the instantaneous frequency.

The present disclosure further provides a pipeline leakage acoustic emission signal denoising system, including:
an acquiring module, configured to acquire pipeline leakage acoustic emission signals;
a decomposing module, configured to obtain a plurality of mode components by decomposing the pipeline leakage acoustic emission signals using a sparrow search algorithm and a variational mode decomposition algorithm;
a dividing module, configured to obtain mode components with more noise and mode components with less noise by dividing the plurality of mode components according to a comprehensive index;
a denoising module, configured to obtain denoised mode components by denoising the mode components with more noise using a wavelet packet adaptive threshold; and
a reconstructing module, configured to obtain denoised leakage acoustic emission signals by carrying out reconstruction according to the mode components with less noise and the denoised mode components.

In one embodiment, the decomposing module specifically includes:
an optimizing unit, configured to obtain the number of mode decomposition layers and a penalty factor by carrying out optimization using the sparrow search algorithm according to the pipeline leakage acoustic emission signals; and
a decomposing unit, configured to obtain a plurality of mode components by decomposing the pipeline leakage acoustic emission signals using the variational mode decomposition algorithm according to the number of mode decomposition layers and the penalty factor.

In one embodiment, the comprehensive index includes a K-L divergence value, a Pearson correlation coefficient, an energy value and a variance contribution rate.

The present disclosure further provides an electronic device, including:
one or more processors; and
a storage device on which one or more programs are stored;
wherein the one or more programs, when executed by the one or more processors, cause the one or more processors to implement the method.

The present disclosure further provides a computer storage medium having a computer program stored thereon, wherein the computer program, when executed by a processor, implements the method described above.

According to the specific embodiment provided by the present disclosure, the present disclosure discloses the following technical effects.

According to the present disclosure, the pipeline leakage acoustic emission signals are decomposed using a sparrow search algorithm and a variational mode decomposition algorithm; the plurality of mode components are divided according to a comprehensive index to obtain mode components with more noise and mode components with less noise; and the denoised mode components are obtained by denoising the mode components with more noise using a wavelet packet adaptive threshold, so as to reserve the pipeline leakage acoustic emission signals as much as possible and improve denoising accuracy.

### BRIEF DESCRIPTION OF THE DRAWINGS

In order to explain the embodiments of the present disclosure or the technical solutions in the prior art more clearly, the drawings that need to be used in the embodiments will be briefly introduced hereinafter. Obviously, the drawings in the following description are only some embodiments of the present disclosure. For those skilled in the art, other drawings can be obtained according to these drawings without creative efforts.

FIG. 1 is a schematic diagram of a pipeline leakage acoustic emission signal denoising method according to the present disclosure.

FIG. 2 is a time-frequency diagram of leakage acoustic emission signals without denoising.

FIG. 3 is a time-frequency diagram of synchronous squeezing transform of denoised leakage acoustic emission signals.

FIG. 4 is a time-frequency diagram of short-time Fourier transform of denoised leakage acoustic emission signals.

FIG. 5 is a time-frequency diagram of synchronous extracting transform of denoised leakage acoustic emission signals.

FIG. 6 is a flowchart of a pipeline leakage acoustic emission signal denoising method according to the present disclosure.

FIG. 7 is a flow chart of SSA-VMD (sparrow search algorithm-variational mode decomposition).

### DETAILED DESCRIPTION OF THE EMBODIMENTS

The technical solutions in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative efforts fall within the scope of protection of the present disclosure.

The present disclosure aims to provide a pipeline leakage acoustic emission signal denoising method, system, device and medium, which can reserve information of the leakage acoustic emission signals and improve the denoising accuracy.

In order to make the above objectives, features and advantages of the present disclosure more obvious and understandable, the present disclosure will be explained in further detail with reference to the drawings and detailed description hereinafter.

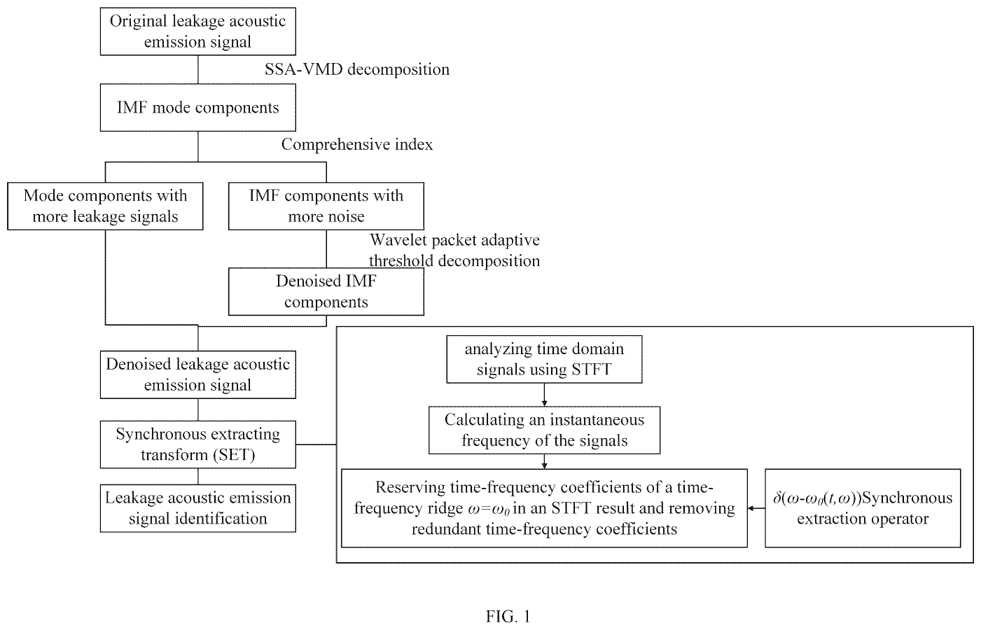

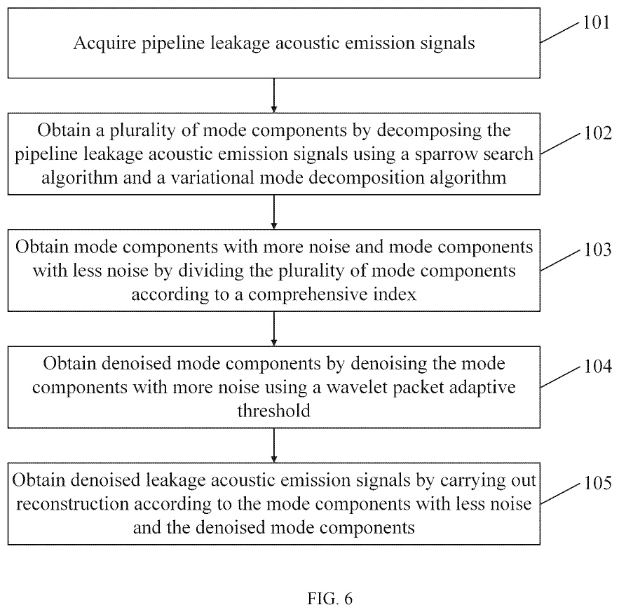

As shown in FIG. 1 and FIG. 6, the present disclosure provides a pipeline leakage acoustic emission signal denoising method, including steps 101-105.

Step 101: pipeline leakage acoustic emission signals are acquired.

Step 102: a plurality of mode components are obtained by decomposing the pipeline leakage acoustic emission signals using a sparrow search algorithm and a variational mode decomposition algorithm.

Step 102 specifically includes: obtaining the number of mode decomposition layers and a penalty factor by optimizing the pipeline leakage acoustic emission signals using the sparrow search algorithm; and obtaining a plurality of mode components by decomposing the pipeline leakage acoustic emission signals using the variational mode decomposition algorithm according to the number of mode decomposition layers and the penalty factor.

Step 103: mode components with more noise and mode components with less noise are obtained by dividing the plurality of mode components according to a comprehensive index. The comprehensive index includes a K-L divergence value, a Pearson correlation coefficient, an energy value and a variance contribution rate.

Step 104: denoised mode components are obtained by denoising the mode components with more noise using a wavelet packet adaptive threshold.

Step 104 specifically includes: obtaining a scale function and a decomposition function by carrying out wavelet packet decomposition on the mode components with more noise; and obtaining denoised mode components by denoising and reconstruction using a hard threshold function according to the scale function and the decomposition function.

Step 105: denoised leakage acoustic emission signals are obtained by performing reconstruction according to the mode components with less noise and the denoised mode components.

In practical application, after the denoised leakage acoustic emission signals are obtained by carrying out reconstruction according to the mode components with less noise and the denoised mode components, the method further includes: obtaining a time-frequency signal by carrying out short-time Fourier transform on the denoised leakage acoustic emission signals; calculating an instantaneous frequency according to phase information of the time-frequency signal; and obtaining time-frequency features of the leakage acoustic emission signals according to a time-frequency coefficient of the time-frequency signal at the instantaneous frequency.

The present disclosure solves the problem that it is difficult to recognize the leakage acoustic emission signals of polyethylene pipeline leakage because it is difficult to extract pure leakage acoustic emission signals of polyethylene pipelines due to environmental noise.

Traditionally, the detection of pipeline leakage signals mainly focuses on metal pipelines, while there is little research on leakage acoustic emission detection of nonmetal pipeline due to a large attenuation and a low frequency range of nonmetal pipelines. The present disclosure can reserve the leakage acoustic emission features of polyethylene pipelines to the greatest extent in the case that the noise features are unknown. By proposing a new time-frequency analysis method of leakage acoustic emission signals, synchronous extracting transform has higher time-frequency aggregation and energy concentration for analysis of pipeline leakage acoustic emission signals when compared with traditional methods such as wavelet transform, synchronous squeezing transform and short-time Fourier transform, thereby better reflecting the time-varying features of the leakage acoustic emission signals.

As shown in FIG. 1, the present disclosure further provides a specific flow of the pipeline leakage acoustic emission signal denoising method in practical application, including steps 1-4.

Step 1: a leakage platform for leakage acoustic emission of polyethylene pipelines is built, and leakage acoustic emission signals of polyethylene pipelines under different pressure conditions are acquired by acoustic emission sensors. The pipeline is a polyethylene pipeline as a nonmetallic pipeline. The acoustic emission sensor has a model of SR10 and a resonance frequency of 1-15 KHz, a pipeline has a wall with a thickness of 18.2 mm, a leakage aperture of 4 mm, and a pipeline pressure of 0.4 MPa, 0.3 MPa and 0.2 MPa. Specifically, acoustic emission sensors are used to acquire leakage acoustic emission signals of polyethylene pipelines under different pressure conditions. The used sensors are low-frequency acoustic emission sensors with a resonance frequency of 10 KHz and a frequency response range of 1 Hz-15 KHz. An air compressor is connected with a surge tank to transport compressed air into the polyethylene pipelines. As the pipeline pressure rises continuously, the pressure readings at both ends of the pipelines are read, and the leakage acoustic emission signals having a pipeline pressure of 0.4 MPa, 0.3 MPa and 0.2 MPa are acquired, respectively. The present disclosure takes the leakage acoustic emission signal acquired by the sensor having a pipeline pressure of 0.4 MPa as an example

Step 2: the penalty factor α and the number of decomposition layers k in the VMD (variational mode decomposition) are optimized using the sparrow optimization algorithm, and the penalty factor and the number of decomposition layers are adaptively determined. SSA-VMD decomposition is carried out on the acquired leakage signals described above, and the sparrow search algorithm is combined with the variational mode decomposition algorithm to adaptively determine the penalty factor and the number of decomposition layers of the variational mode decomposition algorithm. Since a large amount of random noise will inevitably be involved when acquiring leakage acoustic emission signals, these noises make it difficult to extract and identify the features of leakage acoustic emission signals. The sparrow search algorithm (SSA) was put forward in 2020, which is an intelligent optimization algorithm, and is mainly applied to an imprecise system model to realize global optimal, effective and fast search. For variational mode decomposition, the setting of the parameters of the penalty factor and the number of decomposition layers has an important influence on the denoising of leakage acoustic emission signals. At present, the VMD parameters are set by manual experience, which causes ignorance of effective features of leakage acoustic emission signals in the IMF component obtained by decomposition. The sparrow search algorithm is combined with variational mode decomposition to adaptively determine the parameters of the number of decomposition layers and the penalty factor of the variational mode decomposition, and the IMF component obtained after decomposition will not have mode mixing phenomenon, thus ensuring the accuracy of signal reconstruction. Parameter steps of the SSA optimizing the VMD are as follows.

### (1) Sparrow Search Algorithm

Sparrow population is divided into forager, joiner and warner. The mathematical model is as follows.

The expression of the sparrow population position X is:

$$X = [ \begin{matrix}{x}_{1 , 1} & {x}_{1 , 2} & … & {x}_{1 , d} \\ {x}_{2 , 1} & {x}_{2 , 2} & … & {x}_{2 , d} \\ ⋮ & ⋮ & ⋮ & ⋮ \\ {x}_{n , 1} & {x}_{n , 2} & … & {x}_{n , d}\end{matrix} ] , \qquad ( 1 )$$

where n indicates the number of sparrows, d is the dimension of the optimized variable, and x_{n,d} is the position of the n^{th} sparrow. The forager is responsible for looking for the direction of food and population, and the position is updated as follows:

$${X}_{i , j}^{t + 1} = \{ \begin{matrix}{X}_{i , j}^{t} \cdot exp ( \frac{- i}{β \cdot {T}_{max}} ) , {R}_{2} < {f}_{ST} \\ {X}_{i , j}^{t} + Q \cdot L , {R}_{2} … {f}_{ST}\end{matrix} , \qquad ( 2 )$$

where X_{i,j}^{t} is the position of the i^{th} sparrow in the j^{th} dimension, Tₘₐₓ indicates the maximum number of iterations, and R² are random numbers having a range of [0,1], ƒ_{ST} is a safety threshold, ƒ_{ST}∈[0.5,1.0], Q is a random number and follows a normal distribution, L is a matrix with all internal elements being 1, t represents the current iteration, and X_{i,j}^{t+1} is the next iteration position of the i^{th} sparrow in the j^{th} dimension.

The joiner follows the forager to look for food, and the position is updated as follows:

$${X}_{i , j}^{t + 1} = \{ \begin{matrix}Q \cdot exp ( \frac{{X}_{worst} - {X}_{i , j}^{t}}{{i}^{2}} ) , i > n / 2 \\ {X}_{p}^{t + 1} + \vert {X}_{i , j}^{t} - {X}_{p}^{t + 1} \vert \cdot {A}^{+} \cdot L , i \leq n / 2\end{matrix} , \qquad ( 3 )$$

where Xₚ^{t+1} is the optimal position of the forager which is to be updated next time, X_{word} is the worst position, A is the matrix in which 1 or −1 is randomly assigned to the internal elements, and i>n/2 indicates that the probability of starvation of the joiner is high and the population needs to fly to other places to look for food at this time.

The initial position of the warner in the population is random, and the position is updated as follows:

$${X}_{i , j}^{t + 1} = \{ \begin{matrix}{X}_{best}^{t} + β \cdot \vert {X}_{i , j}^{t} - {X}_{best}^{t} \vert ) , {f}_{i} \neq {f}_{g} \\ {X}_{i , j}^{t} + M \cdot ( \frac{\vert {X}_{i , j}^{t} - {X}_{worst}^{t} \vert}{( {f}_{i} - {f}_{w} ) + ε} ) , {f}_{i} = {f}_{g}\end{matrix} , \qquad ( 4 )$$

where X_{best}^{t} is the optimal position of the warner of the current iteration, X_{worst}^{t} is the worst position, M is a random number ranging from −1 to 1, ƒ_{g} and ƒ_{w} indicate the optimal fitness and the worst fitness, ƒᵢ>ƒ_{g} indicates that the sparrow is at the edge of the population at this time, ƒᵢ=ƒ_{g} indicates that the sparrow is in danger in the population and needs to meet other sparrows in the population, ƒᵢ is the fitness value of the current sparrow, and ε is a minimum constant.

### (2) Variational Mode Decomposition

The VMD decomposition is a process of seeking the optimal solution of the constrained variation process, and the specific steps of estimating the frequency bandwidth of the mode function are as follows.

1) For each mode function, an analysis signal with a unilateral spectrum is obtained through Hilbert transform:

$$[ δ ( t ) + \frac{j}{π t} ] * {u}_{k} ( t ) , \qquad ( 5 )$$

where δ(t) is an impact function, J is an imaginary unit, and uₖ(t) is a mode function.

2) A mode function with a unilateral spectrum is mixed with an exponential signal with a central frequency of ωₖ to obtain a baseband signal:

$$[ ( δ ( t ) + \frac{j}{π t} ) * {u}_{k} ( t ) ] {e}^{- j {ω}_{k} t} . \qquad ( 6 )$$

3) The square of the norm of the gradient L² of the demodulated signal is calculated, the bandwidth of each mode is estimated, and the corresponding constrained variation expression is as follows:

$${min}_{\{ {u}_{k} \} , \{ {ω}_{k} \}} \{ {\sum }_{k} {‖ {\partial }_{t} [ ( δ ( t ) + \frac{j}{π t} ) * {u}_{k} ( t ) ] {e}^{- j {ω}_{k} t} ‖}_{2}^{2} \} \qquad ( 7 )$$

$$s . t . {\sum }_{k} {u}_{k} = f .$$

In Formula (7) {uₖ}={u₁, . . . , uₖ} represents k modes after signal decomposition, {ωₖ}={ω₁, . . . ωₖ} represents a set of central frequencies of the decomposed mode, δ(t) is a pulse function, and ƒ is a non-stationary random signal. For constrained variation problems, an augmented Lagrangian function λ(t) and a penalty factor α are introduced to transform the constrained variation into unconstrained variation, and the mathematical expression is:

$$L ( \{ {u}_{k} \} , \{ {ω}_{k} \} , λ ) = α {\sum }_{k} {‖ {\partial }_{t} [ ( δ ( t ) + \frac{j}{π t} ) * {u}_{k} ( t ) ] {e}^{- j {ω}_{k} t} ‖}_{2}^{2} + {‖ f ( t ) - {\sum }_{k} {u}_{k} ( t ) ‖}_{2}^{2} + 〈 λ ( t ) , f ( t ) - {\sum }_{k} {u}_{k} ( t ) 〉 . \qquad ( 8 )$$

According to the above variational mode decomposition theory, the following complete variational mode decomposition algorithm is obtained by carrying out optimization and supplement in the frequency domain.

1) It is assumed that n=0, {uₖ¹}, {ωₖ¹}, {λ¹} is initialized, and λ represents a Lagrange multiplier.

2) It is assumed that n=1, the cycle starts, k=1: K, {uₖ}, {ωₖ} and λ are updated.
a. When ω>0, the value of uₖ is iteratively updated, and the specific mathematical expression is:

$$\{ {\hat{u}}_{k}^{n + 1} \} = \frac{\hat{f} ( ω ) - {\sum }_{i < k} {\hat{u}}_{i}^{n + 1} ( ω ) - {\sum }_{i > k} {\hat{u}}_{i}^{n} ( ω ) + ( {\hat{λ}}^{n} ( ω ) / 2 )}{1 + 2 {α ( ω - {ω}_{k}^{n} )}^{2}} , \qquad ( 9 )$$

where ûₖⁿ⁺¹ is a mode after iterative updating, \hat{ƒ}(ω) is a signal in the frequency domain,

$${\sum }_{i < k} {\hat{u}}_{i}^{n + 1} ( ω )$$

is the sum of mode functions in the frequency domain, ûₖⁿ⁺¹ (ω) is a mode function in the frequency domain after iterative updating, \hat{λ}ⁿ(ω) is a Lagrange multiplier in the frequency domain, ωₖⁿ is a center frequency of the n^{th} mode, and ω indicates an independent variable in the frequency domain.
b. The value of ωₖ is iteratively updated, and the specific iterative expression is:

$${ω}_{k}^{n + 1} = \frac{{\int }_{0}^{∞} ω {\vert {\hat{u}}_{k}^{n + 1} ( ω ) \vert}^{2} d ω}{{\int }_{0}^{∞} {\vert {\hat{u}}_{k}^{n + 1} ( ω ) \vert}^{2} d ω} . \qquad ( 10 )$$

c. The value of λ is iteratively updated:

$${\hat{λ}}^{n + 1} ( ω ) = {\hat{λ}}^{n} + γ [ \hat{f} ( ω ) - {\sum }_{k} {\hat{u}}_{k}^{n + 1} ( ω ) ] , \qquad ( 11 )$$

where γ is an update coefficient of the Lagrange multiplication, β=0 in general. \hat{λ}ₙ is the Lagrange multiplier before iteration.

It is assumed that n=n+1, and the above step 2) is repeated until the following conditions are met:

$${\sum }_{k} \frac{{‖ {u}_{k}^{n + 1} - {u}_{k}^{n} ‖}_{2}^{2}}{{‖ {u}_{k}^{n} ‖}_{2}^{2}} < ε , \qquad ( 12 )$$

where uₖⁿ is a mode function of the n^{th} iteration, uₖⁿ⁺¹ is a mode function of the (n+1)^{th} iteration, and ε is a convergence threshold.

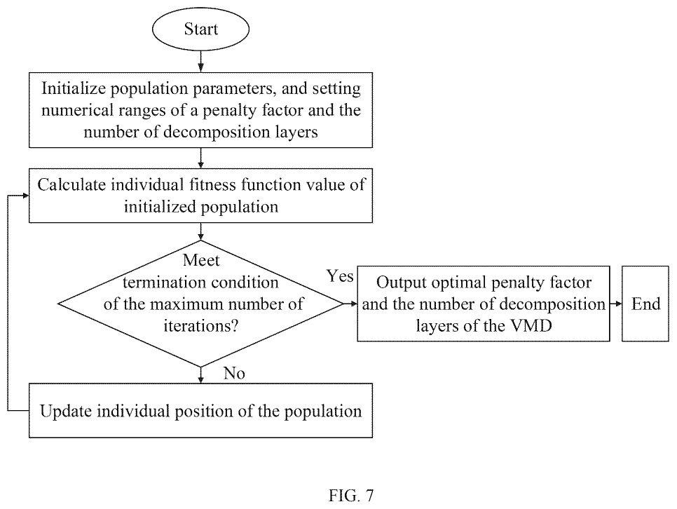

As shown in FIG. 7, the steps of optimizing the number of mode decomposition layers K and the penalty factor α in the VMD using the sparrow search algorithm are as follows:
1) initializing the population parameters (the maximum number of iterations, and the ratio of joined foragers, joiners and warners), and setting the numerical range of the number of mode decomposition layers K and the penalty factor α in the SSA,
2) setting the minimum average envelope entropy of each component to be the fitness function, and calculating the individual fitness function value of the initialized population,
3) determining whether the set maximum number of iterations is reached, if not, updating the positions of the foragers, joiners and warners, and updating the fitness value and the population position according to the minimum average envelope entropy, and
4) when the maximum number of iterations is reached, outputting the optimal number of decomposition layers M and penalty factor α of variational mode decomposition.

Step 3: the obtained optimal parameter combination [m, n] is substituted into the variational mode decomposition algorithm, the leakage acoustic emission signals under different pressure conditions are acquired, and K IMF components are obtained after VMD decomposition. Thereafter, the comprehensive index of the K-L divergence, the Pearson correlation coefficient, the energy value and the variance contribution rate is calculated respectively based on the decomposed mode components. The IMF components with less leakage signals are selected. The mode components with more noise are denoised using the wavelet packet adaptive threshold method, and then are reconstructed with the mode components with less leakage signals. The IMF components with less leakage signals are the mode components with more noise, and the IMF components with more leakage signals are the mode components with less noise.

The K-L divergence values are calculated by the decomposed mode components and the original time-domain leakage acoustic emission signals, respectively. The signal component with the K-L divergence less than a set threshold is selected as the effective component signals, that is, the mode components with less noise, and the other components are the leakage signal components with more noise. Thereafter, the comprehensive index of the Pearson correlation coefficient, the energy value and the variance contribution rate of each mode component and the original signal is calculated, respectively, to verify the correctness of the K-L divergence being used to select effective mode components, so as to avoid affecting the accuracy of the reconstructed signals due to a wrong selection of effective mode components caused by using a single parameter.

K mode components are obtained after decomposing the leakage acoustic emission signals. In order to distinguish the amount of noise in the mode components, the K-L divergences are calculated based on the obtained K mode components and the original time-domain leakage acoustic emission signal first, respectively. A lower K-L divergence value indicates that the mode component has a greater correlation with the original leakage signal and contains the more leakage information.

In order to verify the correctness of the K-L divergence to the selected effective mode components, the comprehensive index of the Pearson correlation coefficient, the energy value and the variance contribution rate is selected. According to the definitions of the Pearson correlation coefficient, the energy value and the variance contribution rate, the Pearson correlation coefficient a, the energy value b and the variance contribution rate C of K mode components and the original leakage signals are calculated, respectively, and the numerical values corresponding to the corresponding indexes are normalized and then added to obtain the comprehensive index x_{zonghe} The larger value x_{zonghe} indicates the selected mode components. The formula is as below,

$${x}_{zonghe} = \frac{a - {a}_{min}}{{a}_{max} - {a}_{min}} + \frac{b - {b}_{min}}{{b}_{max} - {b}_{min}} + \frac{c - {c}_{min}}{{c}_{max} - {c}_{min}} . \qquad ( 13 )$$

The values x_{zonghe} of the mode components IMF1, IMF2, . . . , IMFk are sorted and a threshold is set. The selected mode components according to the threshold are compared with those selected according to the K-L divergence value to verify the correctness of the selection of the effective mode components by the K-L divergence.

In Step 2, the optimal number of decomposition layers and the optimal penalty factor of the VMD are finally output, and then the values of the optimal number of decomposition layers and the optimal penalty factor are taken as the values of the VMD decomposition. The leakage acoustic emission signal is subjected to VMD decomposition to obtain the IMF mode component. However, during processing, the leakage acoustic emission signals are directly taken as an input, and the IMF component is directly obtained. The intermediate processing process (the processing process of the optimal number of decomposition layers and the penalty factor) is not concerned, because the purpose is to adaptively determine two important parameters of the VMD, namely the number of decomposition layers and the penalty factor, and to ensure that the obtained IMF components will not have mode aliasing phenomenon and setting of the two important parameters of the VMD does not rely on manual experience. After SSA-VMD decomposition in Step 2, K mode components are obtained, in which the mode components contain both components with more noise and components with less noise. The purpose of Step 3 is to reserve the components with less noise, carry out adaptive wavelet packet denoising on the components with more noise, and then reconstruct the denoised components and the components with less noise to obtain the leakage acoustic emission signals after joint denoising.

The wavelet packet adaptive threshold denoising method is as follows.

It is assumed that L²(R) is a square integrable space and ƒ(t)[ƒ(t)∈L²(R)] is a square integrable function. Through wavelet packet decomposition, the original signal function ƒ(t) can be decomposed into a linear combination of the scale function (low-frequency components) and the wavelet function (high-frequency components).

$$φ ( t ) = {\sum }_{k} h ( k ) φ ( 2 t - k ) \qquad ( 14 )$$

$$ψ ( t ) = {\sum }_{k} g ( k ) φ ( 2 t - k ) ,$$

where φ(t) represents a scale function, ψ(t) is a wavelet function, h(k) is a coefficient of a high-pass filter, and g(k) is a coefficient of a low-pass filter.

In the wavelet packet algorithm, {dₗ^{j,2n}} and {dₗ^{j,2n+1}} can be obtained by {dₗ^{j+1,n}}:

$$\{ \begin{matrix}{d}_{l}^{j , 2 n} = {\sum }_{k} {h}_{k - 2 l} {d}_{k}^{j + 1 , n} \\ {d}_{l}^{j , 2 n + 1} = {\sum }_{k} {g}_{k - 2 l} {d}_{k}^{j + 1 , n}\end{matrix} , \qquad ( 15 )$$

where dₗ^{j,n} represents a wavelet packet coefficient sequence of the n^{th} sub-band of the j^{th} layer (j=0,1, . . . ) and, k(k=0,1, . . . ) represents the number of wavelet packet coefficients of the n^{th} sub-band of the j^{th} layer (j=0,1, . . . ).

In the wavelet packet reconstruction algorithm, {dₗ^{j+1,n}} can be obtained by {dₗ^{j,2n}} and dₗ^{j+1,2n+1}:

$${d}_{l}^{j + 1 , n} = {\sum }_{k} [ {h}_{l - 2 k} {d}_{k}^{j , 2 n} + {g}_{l - 2 k} {d}_{k}^{j , 2 n + 1} ] , \qquad ( 16 )$$

where hₖ and gₖ are wavelet reconstruction conjugate filter coefficients.

The main steps of wavelet packet threshold denoising are as follows: (1) determining the wavelet packet basis function and the number of decomposition layers of leakage acoustic emission signals; (2) selecting the threshold function; (3) quantizing the wavelet packet coefficients; (3) reconstructing new wavelet packet coefficients. The threshold function can be divided into a hard threshold function and a soft threshold function.

The hard threshold method is as follows:

$$\{ \begin{matrix}{c}_{( j , i )} , & \vert {c}_{( j , i )} \geq λ \vert \\ 0 , & \vert {c}_{( j , i )} < λ \vert\end{matrix} ; \qquad ( 17 )$$

and the soft threshold method is as follows:

$$\{ \begin{matrix}sign ( {c}_{( j , i )} ) \cdot ( \vert {c}_{( j , i )} - λ \vert ) , & \vert {c}_{( j , i )} \geq λ \vert \\ 0 , & \vert {c}_{( j , i )} < λ \vert\end{matrix} . \qquad ( 18 )$$

After selecting the wavelet packet basis function and the number of decomposition layers, the wavelet packet decomposition coefficient is obtained. The hard threshold processing is performed on the wavelet packet coefficient according to the adaptively determined threshold to obtain a new wavelet packet coefficient. Finally, the processed wavelet packet coefficients are reconstructed to obtain the denoised signal. In Formula (17), c_{(j,i)} represents a wavelet packet decomposition coefficient, and λ represents a threshold. The hard threshold method removes more weak signals, while the denoised signal reserves the peak features of the original signal. The peak features in the denoised signal in the soft threshold method will be filtered out.

The wavelet packet adaptive threshold adaptively sets the threshold according to the amplitude features of the leakage acoustic emission signals. Compared with the traditional wavelet packet threshold method, the hard threshold method reduces the poor denoising effect resulted from setting the threshold artificially and subjectively, and can reserve the leakage features of the pipeline leakage acoustic emission signals.

Step 4: time-frequency analysis of leakage acoustic emission signals before denoising is compared with that of leakage acoustic emission signals after denoising, and the synchronous extracting transform (SET) is used to identify the denoised leakage acoustic emission signals. Compared with the traditional synchronous squeezing transform (SST) and short-time Fourier transform, the synchronous extracting transform is used to accurately identify the time-frequency features of the denoised pipeline leakage acoustic emission signals, which has good time-frequency aggregation and energy concentration. The root mean square error and the signal-to-noise ratio are used to evaluate the denoising effect, and the synchronous extracting transform is used to accurately extract the frequency features of the denoised pipeline leakage acoustic emission signals, which has good time-frequency aggregation and energy concentration.

### Synchronous Extracting Transform:

Synchronous extracting transform is the post-processing of STFT (short-time Fourier transform). According to Parseval theorem, STFT can be written as:

$$\begin{matrix}G ( t , ω ) = {\int }_{- ∞}^{+ ∞} s ( u ) \cdot {( g ( u - t ) \cdot {e}^{i ω u} )}^{*} du \\ = {\int }_{- ∞}^{+ ∞} s ( u ) \cdot {( {g}_{ω} ( u ) )}^{*} du \\ = \frac{1}{2 π} {\int }_{- ∞}^{+ ∞} \hat{s} ( ξ ) \cdot {( {g}_{ω} ( ξ ) )}^{*} d ξ\end{matrix} , \qquad ( 19 )$$

where ŝ(ξ) is the Fourier transform of s(u), g_{ω}(ξ) is the Fourier transform of g_{ω}(u), g_{ω}(u) is the introduced variable, the expression is g_{ω}(u)=g(u−t)·e^{iωu}, ( )* indicates complex conjugate operation, and the window function g is a real function. G(t,ω) represents a time spectrum, s(u) is a time domain signal, g(u−t) is a moving window function, u is a time domain variable, and ξ is a frequency domain variable.

After considering the additional phase shift w^{jωt},

$${G}_{e} ( t , ω ) = {\int }_{- ∞}^{+ ∞} g ( u - t ) \cdot s ( u ) \cdot {e}^{- i ω ( u - t )} du . \qquad ( 20 )$$

The modified STFT expression (20) can be expressed as:

$${G}_{ε} ( t , ω ) = \frac{1}{2 π} {\int }_{- ∞}^{+ ∞} \hat{g} ( ω - ξ ) \cdot \hat{s} ( ξ ) \cdot {e}^{i ξ t} d ξ , \qquad ( 21 )$$

where G_{ε}(t,ω) is a modified time-frequency signal, and Gₑ(t,ω) is an additional time-frequency signal after phase-shifting e^{jωt}.

Considering the following pure harmonic signal sₕ(t), the frequency is ω₀, and A is the signal amplitude.

$${s}_{h} ( t ) = {Ae}^{i {ω}_{0} t} . \qquad ( 22 )$$

After Fourier transform of sₕ(t),

$$\hat{s} ( ξ ) = 2 π A \cdot δ ( ξ - {ω}_{0} ) , \qquad ( 23 )$$

where ŝ(ξ) is the frequency spectrum of sₕ(t), and δ is a shock function.

Formula (23) is substituted into Formula (21), so as to obtain the STFT result of the time domain signal sₕ(t):

$${G}_{e} ( t , ω ) = A \cdot \hat{g} ( ω - {ω}_{0} ) \cdot {e}^{i {ω}_{0} t} . \qquad ( 24 )$$

It can be seen from Formula (24) that the STFT result of the harmonic signal consists of a series of harmonic signals with the same frequency ω₀, which is consistent with the original time domain signal sₕ(t). The time-frequency energy of the signal is the most concentrated when ω=ω₀ and has the largest amplitude when A·g(0), but the energy is fuzzy, which cannot accurately characterize the time-varying feature of the signals.

In order to obtain the instantaneous frequency of the STFT, partial derivative of Gₑ(t, ω) is obtained:

$$\begin{matrix}{\partial }_{t} {G}_{ε} ( t , ω ) = {\partial }_{t} ( A \cdot \hat{g} ( ω - {ω}_{0} ) \cdot {e}^{i {ω}_{0} t} ) \\ = A \cdot \hat{g} ( ω - {ω}_{0} ) \cdot {e}^{i {ω}_{0} t} \cdot i \cdot {ω}_{0} \\ = {G}_{ε} ( t , ω ) \cdot i \cdot {ω}_{0}\end{matrix} . \qquad ( 25 )$$

For any (t,ω) Gₑ(t,ω)≠0, the two-dimensional time-frequency of the STFT result of the signal in Formula (24) can be obtained by Formula (26):

$${ω}_{0} ( t , ω ) = - i \cdot \frac{{\partial }_{t} {G}_{e} ( t , ω )}{{G}_{e} ( t , ω )} . \qquad ( 26 )$$

According to Formula (26), ω₀(t, ω) is a two-dimensional time-frequency, |Gₑ(t,ω)| is a maximum value obtained at the time-frequency ridge, and the time-frequency coefficient Gₑ(t,ω₀) is robust. In order to obtain the ideal time-frequency feature of the signals, a high time-frequency resolution analysis is performed on the signal, where the energy at the time-frequency ridge needs to be reserved and the remaining divergent energy needs to be removed. The following formula is introduced:

$$Te ( t , ω ) = {G}_{ε} ( t , ω ) \cdot δ ( ω - {ω}_{0} ( t , ω ) ) , \qquad ( 27 )$$

where Te(t,ω) is the time spectrum after adding a synchronous extraction operator, and

$$δ ( ω - {ω}_{0} ( t , ω ) ) = \{ \begin{matrix}1 , & ω = {ω}_{0} \\ 0 , & ω \neq {ω}_{0}\end{matrix} . \qquad ( 28 )$$

The Formula (27) can be rewritten as:

$$Te ( t , ω ) = \{ \begin{matrix}{G}_{e} ( t , ω ) , & ω = {ω}_{0} \\ 0 , & ω \neq {ω}_{0}\end{matrix} . \qquad ( 29 )$$

In Formula (28), δ(ω−ω₀(t,ω)) is the synchronous extraction operator (SEO), δ(ω−ω₀(t,ω)) is the time-frequency coefficient of Gₑ(t,ω) extracted only at the time-frequency ridge ω=ω₀, and the other time-frequency coefficients are removed. By the extraction method, the SET only reserves the time-frequency information most related to the time-varying features of the leakage acoustic emission signals of polyethylene pipelines, and removes the fuzzy time-frequency energy, thus improving the time-frequency resolution of the original STFT result, making the energy more concentrated, and achieving better identification effect on the leakage acoustic emission signals.

Synchronous extracting transform (SET) includes roughly the following three steps:
step 1: short-time Fourier transform (STFT) is carried out on the signal, and the time signal is transformed into a time-frequency signal;
step 2: the instantaneous frequency is calculated according to the phase information; and
step 3: the time-frequency coefficient of the short-time Fourier transform (STFT) at the instantaneous frequency position is extracted to realize the accurate extraction of the time-frequency features of the signal.

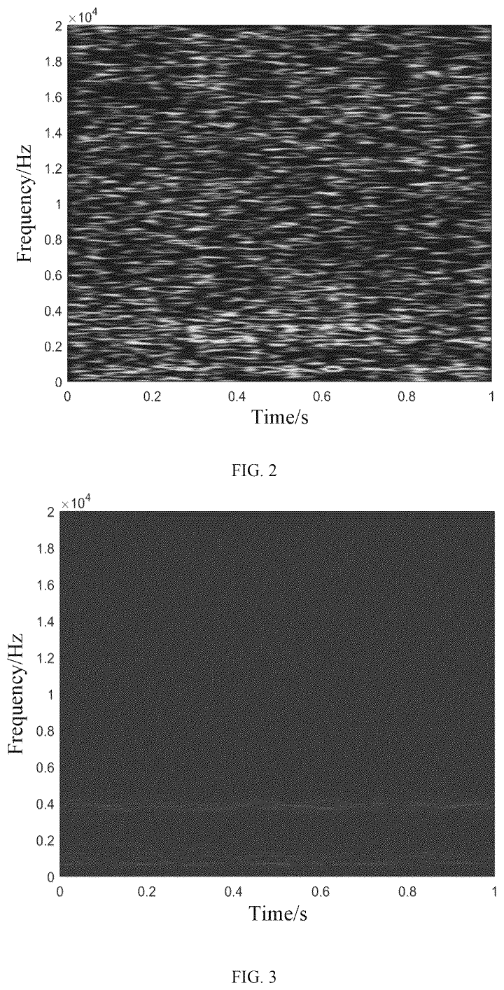

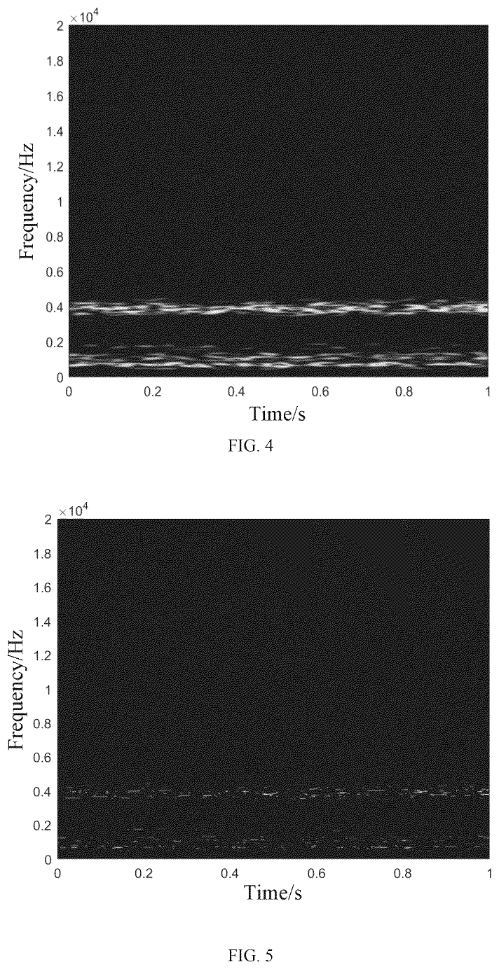

When the denoised leakage acoustic emission signal is identified, the denoised signal is used as input to carry out SET transform. Compared with the traditional short-time Fourier transform (STFT) and synchronous squeezing transform (SST), SET transform has the following outstanding advantages: 1. the SET transform has certain anti-interference ability to noise, and high time-frequency accuracy; and 2. the SET transform has strong time-frequency aggregation and energy concentration, which can clearly identify the frequency features of leakage acoustic emission signals. As shown in FIG. 2, the frequency component of the leakage acoustic emission signal that is not denoised is very complicated, and the leakage acoustic emission signal has been completely submerged in noise. After joint denoising, as shown in FIGS. 3, 4 and 5, FIG. 3 has the shortcomings of unclear time-frequency features and insufficient time-frequency accuracy, and FIG. 4 has the problem of energy divergence. As shown in FIG. 5, SET can overcome the above shortcomings to some extent.

The present disclosure further provides a pipeline leakage acoustic emission signal denoising system, including:
an acquiring module, configured to acquire pipeline leakage acoustic emission signals;
a decomposing module, configured to obtain a plurality of mode components by decomposing the pipeline leakage acoustic emission signals using a sparrow search algorithm and a variational mode decomposition algorithm;
a dividing module, configured to obtain mode components with more noise and mode components with less noise by dividing the plurality of mode components according to a comprehensive index;
a denoising module, configured to obtain denoised mode components by denoising the mode components with more noise using a wavelet packet adaptive threshold; and
a reconstructing module, configured to obtain the denoised leakage acoustic emission signals by carrying out reconstruction according to the mode components with less noise and the denoised mode components.

In one embodiment, the decomposing module specifically includes:
an optimizing unit, configured to obtain the number of mode decomposition layers and a penalty factor by optimizing the pipeline leakage acoustic emission signals using the sparrow search algorithm; and
a decomposing unit, configured to obtain a plurality of mode components by decomposing the pipeline leakage acoustic emission signals using the variational mode decomposition algorithm according to the number of mode decomposition layers and the penalty factor.

In one embodiment, the comprehensive index includes a K-L divergence value, a Pearson correlation coefficient, an energy value and a variance contribution rate.

The present disclosure further provides an electronic device, including: one or more processors; a storage device on which one or more programs are stored; wherein the one or more programs, when executed by the one or more processors, cause the one or more processors to implement the method.

The present disclosure further provides a computer storage medium having a computer program stored thereon, wherein the computer program, when executed by a processor, implements the method.

The present disclosure includes: acquiring leakage signals of polyethylene pipelines under different pressure working conditions by using an acoustic emission sensor; obtaining the optimal penalty factor α and the optimal number of decomposition layers k in the VMD using the Sparrow Search Algorithm (SSA); obtaining the IMF component with the most leakage information in conjunction with the comprehensive index related to a K-L divergence, a Pearson correlation coefficient, an energy value and a variance contribution rate, denoising the IMF component with more noise using a wavelet packet adaptive threshold algorithm, and finally obtaining the reconstructed signal. The reconstructed signal contains the most leakage acoustic emission information. time-frequency analysis of leakage acoustic emission signals before denoising is compared with that of leakage acoustic emission signals after denoising and the synchronous extracting transform (SET) is used to accurately identify the frequency features of the denoised leakage acoustic emission signal, which has good time-frequency aggregation and energy concentration.

In this specification, various embodiments are described in a progressive way. The differences between each embodiment and other embodiments are highlighted, and the same and similar parts of various embodiments can be referred to each other. Since the system disclosed in the embodiment corresponds to the method disclosed in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. A pipeline leakage acoustic emission signal denoising method, comprising:
acquiring pipeline leakage acoustic emission signals;
obtaining a plurality of mode components by decomposing the pipeline leakage acoustic emission signals using a sparrow search algorithm and a variational mode decomposition algorithm;
obtaining mode components with more noise and mode components with less noise by dividing the plurality of mode components according to a comprehensive index;
obtaining denoised mode components by denoising the mode components with more noise using a wavelet packet adaptive threshold; and
obtaining denoised leakage acoustic emission signals by carrying out reconstruction according to the mode components with less noise and the denoised mode components.

2. The pipeline leakage acoustic emission signal denoising method according to claim 1, wherein obtaining the plurality of mode components by decomposing the pipeline leakage acoustic emission signals using the sparrow search algorithm and the variational mode decomposition algorithm, comprises:
obtaining a number of mode decomposition layers and a penalty factor by carrying out optimization using the sparrow search algorithm according to the pipeline leakage acoustic emission signals; and
obtaining the plurality of mode components by decomposing the pipeline leakage acoustic emission signals using the variational mode decomposition algorithm according to the number of mode decomposition layers and the penalty factor.

3. The pipeline leakage acoustic emission signal denoising method according to claim 1, wherein the comprehensive index comprises a K-L divergence value, a Pearson correlation coefficient, an energy value and a variance contribution rate.

4. The pipeline leakage acoustic emission signal denoising method according to claim 1, wherein obtaining the denoised mode components by denoising the mode components with more noise using a wavelet packet adaptive threshold, comprising:
obtaining a scale function and a decomposition function by carrying out wavelet packet decomposition on the mode components with more noise; and
obtaining the denoised mode components by denoising and reconstruction using a hard threshold function according to the scale function and the decomposition function.

5. The pipeline leakage acoustic emission signal denoising method according to claim 1, wherein after obtaining the denoised leakage acoustic emission signals by carrying out reconstruction according to the mode components with less noise and the denoised mode components, the method further comprises:
obtaining a time-frequency signal by carrying out a short-time Fourier transform on the denoised leakage acoustic emission signals;
calculating an instantaneous frequency according to phase information of the time-frequency signal; and
obtaining time-frequency features of the leakage acoustic emission signals according to a time-frequency coefficient of the time-frequency signal at the instantaneous frequency.

6. An electronic device, comprising:
one or more processors; and
a storage device on which one or more programs are stored;
wherein the one or more programs, when executed by the one or more processors, cause the one or more processors to implement:
acquiring pipeline leakage acoustic emission signals;
obtaining a plurality of mode components by decomposing the pipeline leakage acoustic emission signals using a sparrow search algorithm and a variational mode decomposition algorithm;
obtaining mode components with more noise and mode components with less noise by dividing the plurality of mode components according to a comprehensive index;
obtaining denoised mode components by denoising the mode components with more noise using a wavelet packet adaptive threshold; and
obtaining denoised leakage acoustic emission signals by carrying out reconstruction according to the mode components with less noise and the denoised mode components.

7. The electronic device according to claim 6, wherein obtaining the plurality of mode components by decomposing the pipeline leakage acoustic emission signals using the sparrow search algorithm and the variational mode decomposition algorithm, comprises:
obtaining a number of mode decomposition layers and a penalty factor by carrying out optimization using the sparrow search algorithm according to the pipeline leakage acoustic emission signals; and
obtaining the plurality of mode components by decomposing the pipeline leakage acoustic emission signals using the variational mode decomposition algorithm according to the number of mode decomposition layers and the penalty factor.

8. The electronic device according to claim 6, wherein the comprehensive index comprises a K-L divergence value, a Pearson correlation coefficient, an energy value and a variance contribution rate.

9. The electronic device according to claim 6, wherein obtaining the denoised mode components by denoising the mode components with more noise using a wavelet packet adaptive threshold, comprising:
obtaining a scale function and a decomposition function by carrying out wavelet packet decomposition on the mode components with more noise; and
obtaining the denoised mode components by denoising and reconstruction using a hard threshold function according to the scale function and the decomposition function.

10. The electronic device according to claim 6, wherein after obtaining the denoised leakage acoustic emission signals by carrying out reconstruction according to the mode components with less noise and the denoised mode components, the method further comprises:
obtaining a time-frequency signal by carrying out a short-time Fourier transform on the denoised leakage acoustic emission signals;
calculating an instantaneous frequency according to phase information of the time-frequency signal; and
obtaining time-frequency features of the leakage acoustic emission signals according to a time-frequency coefficient of the time-frequency signal at the instantaneous frequency.

11. A computer storage medium having a computer program stored thereon, wherein the computer program, when executed by a processor, implements:
acquiring pipeline leakage acoustic emission signals;
obtaining a plurality of mode components by decomposing the pipeline leakage acoustic emission signals using a sparrow search algorithm and a variational mode decomposition algorithm;
obtaining mode components with more noise and mode components with less noise by dividing the plurality of mode components according to a comprehensive index;
obtaining denoised mode components by denoising the mode components with more noise using a wavelet packet adaptive threshold; and
obtaining denoised leakage acoustic emission signals by carrying out reconstruction according to the mode components with less noise and the denoised mode components.

12. The computer storage medium according to claim 11, wherein obtaining the plurality of mode components by decomposing the pipeline leakage acoustic emission signals using the sparrow search algorithm and the variational mode decomposition algorithm, comprises:
obtaining a number of mode decomposition layers and a penalty factor by carrying out optimization using the sparrow search algorithm according to the pipeline leakage acoustic emission signals; and
obtaining the plurality of mode components by decomposing the pipeline leakage acoustic emission signals using the variational mode decomposition algorithm according to the number of mode decomposition layers and the penalty factor.

13. The computer storage medium according to claim 11, wherein the comprehensive index comprises a K-L divergence value, a Pearson correlation coefficient, an energy value and a variance contribution rate.

14. The computer storage medium according to claim 11, wherein obtaining the denoised mode components by denoising the mode components with more noise using a wavelet packet adaptive threshold, comprising:
obtaining a scale function and a decomposition function by carrying out wavelet packet decomposition on the mode components with more noise; and
obtaining the denoised mode components by denoising and reconstruction using a hard threshold function according to the scale function and the decomposition function.

15. The computer storage medium according to claim 11, wherein after obtaining the denoised leakage acoustic emission signals by carrying out reconstruction according to the mode components with less noise and the denoised mode components, the method further comprises:
obtaining a time-frequency signal by carrying out a short-time Fourier transform on the denoised leakage acoustic emission signals;
calculating an instantaneous frequency according to phase information of the time-frequency signal; and
obtaining time-frequency features of the leakage acoustic emission signals according to a time-frequency coefficient of the time-frequency signal at the instantaneous frequency.
